(19) United States
(12) Patent Application Publication
(10) Pub. No.: US 2025/0314858 A1
(43) Pub. Date: Oct. 9, 2025

(54) CAMERA OPTICAL LENS

(71) Applicant: Changzhou AAC Raytech Optronics Co., Ltd., Changzhou City (CN)

(72) Inventors: Wei Sun, Changzhou (CN); Shunda Zhou, Changzhou (CN); Congfang Si, Changzhou (CN)

(21) Appl. No.: 18/777,614

(22) Filed: Jul. 19, 2024

(30) Foreign Application Priority Data
Apr. 8, 2024 (CN) 202410422088.X

(51) Int. Cl. G02B 13/00; G02B 1/04; G02B 9/62

(52) U.S. Cl. CPC G02B 13/0045; G02B 1/041; G02B 9/62; G02B 13/0055

(57) ABSTRACT

The present disclosure relates to the field of optical lenses, and discloses a camera optical lens sequentially comprising seven lenses from an object side to an image side: a first lens having positive refractive power, a second lens having negative refractive power, a third lens having negative refractive power, a fourth lens having positive refractive power, a fifth lens having negative refractive power, a sixth lens having positive refractive power, and a seventh lens having negative refractive power; which satisfy −0.25≤f12/f34567≤0.05; 0.13≤|TEP/SAG11|*(f/R1)≤2.80; 0.15≤SZD1/HZD1≤0.30; 0.07≤SZD2/HZD2≤0.25.

### TECHNICAL FIELD

The present disclosure relates to the field of optical lens and, in particular, to a camera optical lens applicable to handheld terminal devices such as smart phones, digital cameras, and camera devices such as monitors and PC lenses, vehicle-mounted lenses.

### BACKGROUND

In recent years, with the rise of various smart devices, the demand for a miniaturized camera optical lens has gradually increased. Moreover, since the pixel size of the optical sensor is reduced, and the current electronic product tends to be light weight, thin and portable, the miniaturized camera optical lens with good imaging quality has become a mainstream of the current market. In order to obtain better imaging quality, a multi-lens structure is mostly used. In addition, with the development of technology and the increase of diversified requirements of users, under the condition that the pixel area of the optical sensor is continuously reduced and the requirements on the imaging quality of the system are continuously improved, the structure with seven lenses gradually appears in the lens design. There is an urgent need for an optical camera lens having excellent optical characteristics such as small aberration, high light flux, good processability and low assembling sensitivity.

### SUMMARY

In view of the above problems, an object of the present disclosure is to provide a camera optical lens, which has good optical performance and meets design requirements of small aberration, high light flux, good processability and low assembling sensitivity.

In order to achieve the above object, a first aspect of the present disclosure provides a camera optical lens. The camera optical lens sequentially includes an aperture stop and seven lenses from an object side to an image side: a first lens having positive refractive power, a second lens having negative refractive power, a third lens having negative refractive power, a fourth lens having positive refractive power, a fifth lens having negative refractive power, a sixth lens having positive refractive power, and a seventh lens having negative refractive power. An object-side surface of the first lens is convex, an image-side surface of the first lens is concave; an object-side surface of the second lens is convex, an image-side surface of the second lens is concave; an image-side surface of the third lens is concave; an object-side surface of the fourth lens is convex, an image-side surface of the fourth lens is convex; an image-side surface of the fifth lens is concave; an object-side surface of the sixth lens is convex; an image-side surface of the seventh lens is concave. A combined focal length of the first lens and the second lens is defined as f12, a combined focal length of the third lens, the fourth lens, the fifth lens, the sixth lens and the seventh lens is defined as f34567, a distance from the aperture stop to a center of the object-side surface of the first lens along an optical axis direction is defined as TEP, a sagittal height at a maximum optical radius of the object-side surface of the sixth lens is defined as SAG11, a focal length of the camera optical lens is defined as f, a central curvature radius of the object-side surface of the first lens in the paraxial region is defined as R1, the object-side surface and an image-side surface of the sixth lens each comprise at least one critical point, a critical point on the object-side surface of the sixth lens closest to the optical axis is defined as a first object side critical point, a vertical distance between the first object side critical point and the optical axis is defined as HZD1, a sagittal height of the first object side critical point is defined as SZD1, a critical point on the image-side surface of the sixth lens closest to the optical axis is defined as a first image side critical point, a vertical distance between the first image side critical point and the optical axis is defined as HZD2, a sagittal height of the first image side critical point is defined as SZD2, a focal length of the fifth lens is defined as f5, a focal length of the sixth lens is defined as f6, an on-axis distance between the image-side surface of the first lens and the object-side surface of the second lens is defined as d2, an on-axis distance between the image-side surface of the second lens and an object-side surface of the third lens is defined as d4, an on-axis distance between the image-side surface of the third lens and the object-side surface of the fourth lens is defined as d6, a sagittal height at a maximum optical radius of an object-side surface of the fifth lens is defined as SAG51, an on-axis distance between the image-side surface of the fourth lens and the object-side surface of the fifth lens is defined as d8, and following relational expressions are satisfied:

$$- 0.25 ⩽ f 12 / f 34567 ⩽ 0.05 ;$$

$$0.13 ⩽ \vert TEP / SAG 11 \vert * ( f / R 1 ) ⩽ 2.8 ;$$

$$0.15 ⩽ SZD 1 / HZD 1 ⩽ 0.3 ;$$

$$0.07 ⩽ SZD 2 / HZD 2 ⩽ 0.25 ;$$

$$- 5. ⩽ ( f 5 - f 6 ) / f ⩽ - 1.4 ;$$

$$1.2 ⩽ d 4 / ( d 2 + d 6 ) ⩽ 2. ; and$$

$$- 1.5 ⩽ SAG 51 / d 8 ⩽ - 0.9 .$$

As an improvement, a following relational expression is satisfied: −0.21≤f12/f34567≤0.04.

As an improvement, a following relational expression is satisfied: 0.15≤|TEP/SAG11|*(f/R1)≤2.50.

As an improvement, a following relational expression is satisfied: 0.18≤SZD1/HZD1≤0.25.

As an improvement, a following relational expression is satisfied: 0.08≤SZD2/HZD2≤0.22.

As an improvement, a following relational expression is satisfied: −4.40≤(f5−f6)/f≤−1.70.

As an improvement, a following relational expression is satisfied: 1.30≤d4/(d2+d6)≤1.85.

As an improvement, a following relational expression is satisfied: −1.25≤SAG51/d8≤−0.95.

As an improvement, a sagittal height at a maximum optical radius of an object-side surface of the sixth lens is defined as SAG61, a sagittal height at a maximum optical radius of an image-side surface of the sixth lens is defined as SAG62, an on-axis thickness of the sixth lens is defined as d11, and a following relational expression is satisfied: 0.20≤(SAG61−SAG62)/d11≤0.50.

As an improvement, a following relational expression is satisfied: 0.23≤(SAG61−SAG62)/d11≤0.45.

As an improvement, a central curvature radius of the object-side surface of the second lens in the paraxial region is defined as R3, a central curvature radius of the image-side surface of the fifth lens in the paraxial region is defined as R10, and a following relational expression is satisfied: 0.28≤R3/R10≤2.65.

As an improvement, a following relational expression is satisfied: 0.33≤R3/R10≤2.28.

As an improvement, the first lens is made of glass.

A second aspect of the present disclosure provides a camera optical lens. The camera optical lens sequentially includes an aperture stop and seven lenses from an object side to an image side: a first lens having positive refractive power, a second lens having negative refractive power, a third lens having negative refractive power, a fourth lens having positive refractive power, a fifth lens having negative refractive power, a sixth lens having positive refractive power, and a seventh lens having negative refractive power. An object-side surface of the first lens is convex, an image-side surface of the first lens is concave; an object-side surface of the second lens is convex, an image-side surface of the second lens is concave; an image-side surface of the third lens is concave; an object-side surface of the fourth lens is convex, an image-side surface of the fourth lens is convex; an image-side surface of the fifth lens is concave; an object-side surface of the sixth lens is convex; an image-side surface of the seventh lens is concave. A combined focal length of the first lens and the second lens is defined as f12, a combined focal length of the third lens, the fourth lens, the fifth lens, the sixth lens and the seventh lens is defined as f34567, a distance from the aperture stop to a center of the object-side surface of the first lens along an optical axis direction is defined as TEP, a sagittal height at a maximum optical radius of the object-side surface of the sixth lens is defined as SAG11, a focal length of the camera optical lens is defined as f, a central curvature radius of the object-side surface of the first lens in the paraxial region is defined as R1, the object-side surface and an image-side surface of the sixth lens each comprise at least one critical point, a critical point on the object-side surface of the sixth lens closest to the optical axis is defined as a first object side critical point, a vertical distance between the first object side critical point and the optical axis is defined as HZD1, a sagittal height of the first object side critical point is defined as SZD1, a critical point on the image-side surface of the sixth lens closest to the optical axis is defined as a first image side critical point, a vertical distance between the first image side critical point and the optical axis is defined as HZD2, a sagittal height of the first image side critical point is defined as SZD2, the object-side surface and the image-side surface of the sixth lens comprise at least one arrest point, the object-side surface of the sixth lens comprises a first object side arrest point closest to the optical axis and a second object side arrest point other than the first object side arrest point, a vertical distance from the first object side arrest point to the optical axis is defined as HFD1, a sagittal height of the first object side arrest point is defined as SFD1, a vertical distance from the second object side arrest point to the optical axis is defined as HFD2, a sagittal height of the second object side arrest point is defined as SFD2, the image-side surface of the sixth lens comprises a first image side arrest point closest to the optical axis, a vertical distance between the first image side arrest point and the optical axis is defined as HFD3, a sagittal height of the first image side arrest point is defined as SFD3, and following relational expressions are satisfied:

$$- 0.25 ⩽ f 12 / f 34567 ⩽ 0.05 ;$$

$$0.13 ⩽ \vert TEP / SAG 11 \vert * ( f / R 1 ) ⩽ 2.8 ;$$

$$0.15 ⩽ SZD 1 / HZD 1 ⩽ 0.3 ;$$

$$0.07 ⩽ SZD 2 / HZD 2 ⩽ 0.25 ;$$

$$0.15 ⩽ SFD 1 ) / HFD 1 ⩽ 0.28 ;$$

$$- 0.12 ⩽ SFD 2 / HFD 2 ⩽ 0.002 ; and$$

$$- 0.1 ⩽ SFD 3 / HFD 3 ⩽ 0.45 .$$

As an improvement, a following relational expression is satisfied: −0.21≤f12/f34567≤0.04.

As an improvement, a following relational expression is satisfied: 0.15≤|TEP/SAG11|*(f/R1)≤2.50.

As an improvement, a following relational expression is satisfied: 0.18≤SZD1/HZD1≤0.25.

As an improvement, a following relational expression is satisfied: 0.08≤SZD2/HZD2≤0.22.

As an improvement, a following relational expression is satisfied: 0.18≤SFD1/HFD1≤0.25.

As an improvement, a following relational expression is satisfied: −0.10≤SFD2/HFD2≤0.002.

As an improvement, a following relational expression is satisfied: 0.11≤SFD3/HFD3≤0.38.

As an improvement, a focal length of the sixth lens is f6, an on-axis thickness of the sixth lens is d11, and a following relational expression is satisfied: 6.58≤f6/d11≤11.78.

As an improvement, a following relational expression is satisfied: 7.69≤f6/d11≤9.85.

As an improvement, the first lens is made of glass.

The present disclosure has following beneficial effects: the camera optical lens according to the present disclosure has excellent optical characteristics, and has characteristics of small aberration, high light flux, good processability, aperture stop with low assembling sensitivity, wide-angle and ultra-thin, which is suitable for a mobile phone camera lens assembly composed of camera elements such as CCD, CMOS with high definition, a WEB camera lens assembly and a vehicle-mounted lens assembly.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a camera optical lens according to Embodiment 1 of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Embodiment 2 of the present disclosure; FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Embodiment 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9; FIG. 13 is a structural schematic diagram of a camera optical lens according to Embodiment 4 of the present disclosure;

FIG. 14 is a schematic diagram of longitudinal aberration of the camera optical lens shown in FIG. 13; FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a structural schematic diagram of a camera optical lens according to Embodiment 5 of the present disclosure;

FIG. 18 is a schematic diagram of longitudinal aberration of the camera optical lens shown in FIG. 17;

FIG. 19 is a schematic diagram of lateral color of the camera optical lens shown in FIG. 17; and

FIG. 20 is a schematic diagram of field curvature and distortion of the camera optical lens shown in FIG. 17.

### DESCRIPTION OF EMBODIMENTS

In order to more clearly illustrate objectives, technical solutions, and advantages of the embodiments of the present disclosure, the technical solutions in the embodiments of the present disclosure are clearly and completely described in details with reference to the drawings. The described embodiments are merely part of the embodiments of the present disclosure rather than all of the embodiments. All other embodiments obtained by those skilled in the art based on the embodiments of the present disclosure shall fall into the protection scope of the present disclosure.

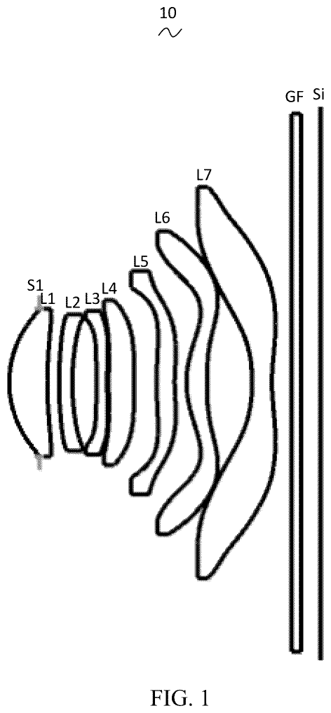

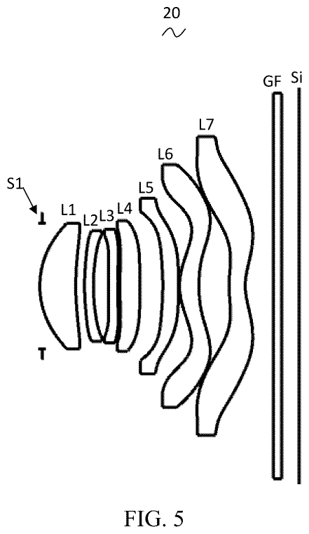

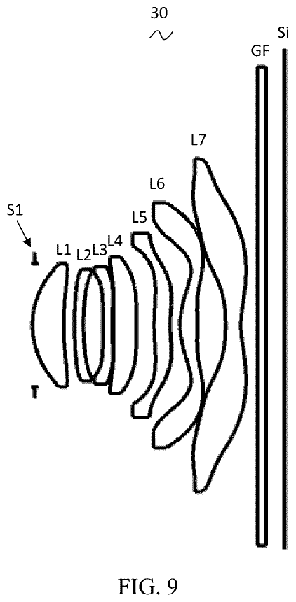

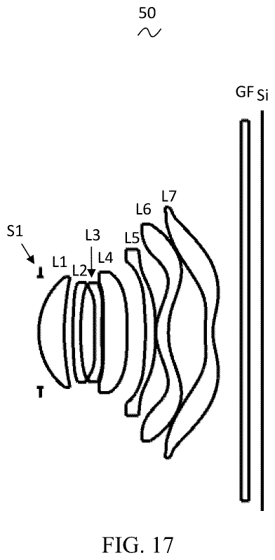

Referring to FIGS. 1-20, the present disclosure provides camera optical lenses 10, 20, 30, 40 and 50. FIG. 1, FIG. 5, FIG. 9, FIG. 13 and FIG. 17 show camera optical lenses 10, 20, 30, 40 and 50 according to the present disclosure. The camera optical lenses 10, 20, 30, 40 and 50 each include seven lenses. The camera optical lens sequentially includes from an object side to an image side: an aperture stop S1, a first lens L1, a second lens L2, a third lens L3, a fourth lens L4, a fifth lens L5, a sixth lens L6 and a seventh lens L7. An optical element such as a grating filter may be provided between the seventh lens L7 and an image surface Si.

The first lens L1 is made of glass, the second lens L2 is made of plastic material, the third lens L3 is made of plastic material, the fourth lens L4 is made of plastic material, the fifth lens L5 is made of plastic material, the sixth lens L6 is made of plastic material, and the seventh lens L7 is made of plastic material. The lenses may also be made of other materials.

The object-side surfaces and the image-side surfaces of the first lens L1, the second lens L2, the third lens L3, the fourth lens L4, the fifth lens L5, the sixth lens L6, and the seventh lens L7 are aspheric surfaces, respectively.

The refractive powers of the first lens L1, the second lens L2, the third lens L3, the fourth lens L4, the fifth lens L5, the sixth lens L6, and the seventh lens L7 are positive, negative, negative, positive, negative, positive and negative, respectively. An object-side surface of the first lens L1 is convex, and an image-side surface of the first lens L1 is concave. An object-side surface of the second lens L2 is convex, and an image-side surface of the second lens L2 is concave. An image-side surface of the third lens L3 is concave, and an object-side surface of the third lens L3 is concave or a convex. An object-side surface of the fourth lens L4 is convex, and an image-side surface of the fourth lens L4 is convex. An image-side surface of the fifth lens L5 is concave, and an object-side surface of the fifth lens L5 is concave or convex. An object-side surface of the sixth lens L6 is convex, and an image-side surface of the sixth lens L6 is concave or convex. An image-side surface of the seventh lens L7 is concave, and an object-side surface of the seventh lens L7 is concave or convex.

A combined focal length of the first lens L1 and the second lens L2 is defined as f12, a combined focal length of the third lens L3, fourth lens L4, fifth lens L5, the sixth lens L6 and the seventh lens L7 is defined as f34567, and a following relational expression is satisfied: −0.25≤f12/f34567≤0.05; and a following relational expression is satisfied: −0.21≤f12/f34567≤0.04. Within the range of the relational expression, it is beneficial to the reasonable distribution of the refractive power of each lens in space and reduce the aberration of the optical system by reasonable providing the ratio of the combined focal length of the first lens L1 and the second lens L2 to the combined focal length of the third lens L3, the fourth lens L4, the fifth lens L5, the sixth lens L6 and the seventh lens L7.

A distance from the aperture stop to the center of the object-side surface of the first lens L1 along the optical axis direction is defined as TEP, the sagittal height at a maximum optical radius of the object-side surface of the first lens is defined as SAG11, a focal length of the camera optical lens is defined as f, a central curvature radius of the object-side surface of the first lens L1 in the paraxial region is defined as R1, and a following relational expression is satisfied: 0.13≤|TEP/SAG11|*(f/R1)≤2.80; and a following relational expression is satisfied: 0.15≤|TEP/SAG11|*(f/R1)≤2.50. Within the range of the relational expression, it is beneficial to improve the processing rate and control the focal length of the system within a reasonable range by reasonably controlling the position of the aperture stop and the sagittal height of the object-side surface of the first lens, the camera optical lens has a higher light intake, and the object-side surface of the first lens has a reasonable curvature.

A critical point of the object-side surface of the sixth lens L6 closest to the optical axis is defined as a first object side critical point. The vertical distance between the first object side critical point and the optical axis is HZD1, the sagittal height of the first object side critical point is SZD1, and a following relational expression is satisfied: 0.15≤SZD1/HZD1≤0.30; and a following relational expression is satisfied: 0.18≤SZD1/HZD1≤0.25. Within the range of the relational expression, it is beneficial to correct the aberration caused by the first five lenses by reasonably controlling the shape of the object-side surface of the sixth lens, especially the ratio of the sagittal height to the height of the first off-axis critical point.

A critical point of the image-side surface of the sixth lens L6 closest to the optical axis is defined as a first image side critical point. The vertical distance between the first image side critical point and the optical axis is HZD2, the sagittal height of the first image side critical point is SZD2, and a following relational expression is satisfied: 0.07≤SZD2/HZD2≤0.25; and a following relational expression is satisfied: 0.08≤SZD2/HZD2≤0.22. Within the range of the relational expression, it is beneficial to adjust the direction of the light after passing through, so that the light transitions smoothly between the sixth lens and the seventh lens, and the assembling sensitivity between the sixth lens and the seventh lens is reduced by reasonably controlling the shape of the image-side surface of the sixth lens, especially the ratio of the sagittal height to the height of the first off-axis critical point.

A focal length of the fifth lens L5 is defined as f5, a focal length of the sixth lens is defined as f6, and a following relational expression is satisfied: −5.00≤(f5−f6)/f≤−1.40; and a following relational expression is satisfied: −4.40≤(f5−f6)/f≤−1.70. Within the range of the relational expression, the spherical aberration generated by the fifth lens and the sixth lens may be balanced.

An on-axis distance between the image-side surface of the first lens L1 and the object-side surface of the second lens L2 is defined as d2, and an on-axis distance between the image-side surface of the second lens L2 and the object-side surface of the third lens L3 is defined as d4, an on-axis distance between the image-side surface of the third lens L3 and the object-side surface of the fourth lens L4 is defined as d6, and a following relational expression is satisfied: 1.20≤d4/(d2+d6)≤2.00; and a following relational expression is satisfied: 1.30≤d4/(d2+d6)≤1.85. Within the range of the relational expression, reasonably providing the air gap between the first lens and the fourth lens may reasonably design the peripheral structure of the lens, especially the thickness of the peripheral portion, so that the design of the connection structure between the lenses is more diversified.

The sagittal height at the maximum optical radius of the object-side surface of the fifth lens L5 is defined as SAG51, an on-axis distance between the image-side surface of the fourth lens L4 to the object-side surface of the fifth lens L5 is d8, and a following relational expression is satisfied: −1.50≤SAG51/d8≤−0.90; and a following relational expression is satisfied: −1.25≤SAG51/d8≤−0.95. Within the range of the relational expression, the axial interval between the fourth lens and the fifth lens and sagittal height at the maximum optical radius of the object-side surface of the fifth lens are reasonably controlled to avoid the interference between the fourth lens and the fifth lens.

The sagittal height at a maximum optical radius of the object-side surface of the sixth lens L6 is defined as SAG61, the sagittal height at a maximum optical radius of the image-side surface of the sixth lens L6 is defined as SAG62, an on-axis thickness of the sixth lens is defined as d11, and a following relational expression is satisfied: 0.20≤(SAG61−SAG62)/d11≤0.50;and a following relational expression is satisfied: 0.23≤(SAG61ΔSAG62)/d11≤0.45. Within the range of the relational expression, the shape of the sixth lens is reasonably controlled to improve the processability.

A central curvature radius of the object-side surface of the second lens L2 in the paraxial region is defined as R3, a central curvature radius of the image-side surface of the fifth lens L5 in the paraxial region is defined as R10, and a following relational expression is satisfied: 0.28≤R3/R10≤2.65; and a following relational expression is satisfied: 0.33≤R3/R10≤2.28. Within the range of the relational expression, it is beneficial to correction of chromatic aberration, and achieve the balance of various aberrations.

The object-side surface of the sixth lens L6 includes a first object side arrest point closest to the optical axis and a second object side arrest point other than the first object side arrest point, the vertical distance between the first object side arrest point and the optical axis is defined as HFD1, the sagittal height of the first object side arrest point is defined as SFD1, and a following relational expression is satisfied: 0.15≤SFD1/HFD1≤0.28; and a following relational expression is satisfied: 0.18≤SFD1/HFD1≤0.25. Within the range of the relational expression, it is beneficial to correct the aberration caused by the first five lenses by reasonably controlling the shape of the object-side surface of the sixth lens, especially the ratio of the sagittal height to the height of the first off-axis arrest point.

The vertical distance between the second object side arrest point and the optical axis is defined as HFD2, the sagittal height of the second object side arrest point is defined as SFD2, and a following relational expression is satisfied: −0.12≤SFD2/HFD2≤0.002; and a following relational expression is satisfied: −0.10≤SFD2/HFD2≤0.002. Within the range of the relational expression, it is beneficial to correct the aberration especially the field curvature caused by the first five lenses by reasonably controlling the shape of the object-side surface of the sixth lens, especially the ratio of the sagittal height to the height of the second off-axis arrest point.

The image-side surface of the sixth lens L6 includes an image side arrest point closest to the optical axis, the vertical distance between the first image side arrest point and the optical axis is defined as HFD3, the sagittal height of the first image side arrest point is SFD3, and a following relational expression is satisfied: 0.10≤SFD3/HFD3≤0.45; and a following relational expression is satisfied: 0.11≤SFD3/HFD3≤0.38. Within the range of the relational expression, it is beneficial to adjust the direction of the light after passing through, so that the large field of view light may reach the higher position of the seventh lens and increase the field of view by reasonably controlling the shape of the image-side surface of the sixth lens, especially the ratio of the sagittal height to the height of the first off-axis arrest point.

A focal length of the sixth lens L6 is defined as f6, an on-axis thickness of the sixth lens is d11, and a following relational expression is satisfied: 6.58≤f6/d11≤11.78; and a following relational expression is satisfied: 7.69≤f6/d11≤9.85, the radius-thickness ratio of the sixth lens may be controlled within a reasonable range, which is beneficial to form lenses, reduce stress residue and bad appearance of large lenses by controlling the ratio of the effective focal length of the sixth lens to the central thickness of the sixth lens on the optical axis.

The first lens L1 is made of glass, and the abbe number of glass is matched with the resin lens to reduce chromatic aberration and improve performance of the optical camera lens.

Compared with the prior art, the camera optical lens provided by the present disclosure is configured with −0.25≤f12/f34567≤0.05; 0.13≤|TEP/SAG11|*(f/R1)≤2.80; 0.15≤SZD1/HZD1≤0.30; 0.07≤SZD2/HZD2≤0.25; −5.00≤(f5−f6)/f≤−1.40; 1.20≤d4/(d2+d6)≤2.00; −1.50≤SAG51/d8≤−0.90 to achieve a following technical effects: it may reduce the aberration of the optical system and make the camera optical lens have a higher light intake. In addition, the object-side surface of the first lens has a reasonable curvature to improve the processability. The focal length of the system is controlled within a reasonable range, the assembling sensitivity between the sixth lens and the seventh lens is reduced, the spherical aberration generated by the fifth lens and the sixth lens is balanced, and the design of the connection structure between the lenses is more diversified; and the interference between the fourth lens and the fifth lens is avoided.

In addition, compared with the prior art, the camera optical lens provided by the present disclosure is configured with −0.25≤f12/f34567≤0.05; 0.13≤|TEP/SAG11|*(f/R1)≤2.80; 0.15≤SZD1/HZD1≤0.30; 0.07≤SZD2/HZD2≤0.25; 0.15≤SFD1/HFD1≤0.28; −0.12≤SFD2/HFD2≤0.002; and 0.10≤SFD3/HFD3≤0.45 to achieve following technical effects: it may reduce the aberration of the optical system and make the camera optical lens have a higher light flux. In addition, the object-side surface of the first lens has a reasonable curvature to improve the processability. The focal length of the system is controlled within a reasonable range, the assembling sensitivity between the sixth lens and the seventh lens is reduced, the aberration caused by the first five lenses is corrected, especially the field curvature, and the direction of the light passing through is adjusted, so that the large field of view light may reach the higher position of the seventh lens, the field of view is increased.

The camera optical lens of the present disclosure will be described below with examples. The reference signs recited in each example are shown below. The units of focal length, on-axis distance, central curvature radius, on-axis thickness, the vertical distance from arrest point to the optical axis, the vertical distance from sagittal height, critical point to the optical axis and sagittal height are mm.

TTL: total optical length from the object-side surface of the first lens to an image surface of the camera optical lens along an optic axis (the on-axis distance from the object-side surface of the first lens L1 to the image surface Si), in mm.

Aperture Number FNO: refers to the ratio of the effective focal length of the camera optical lens to the entrance pupil diameter of the camera optical lens.

Sagittal Height: the distance from the point on the surface to the center point on the optical axis along the optical axis is positive on the right side of the center point and negative on the left side of the center point.

1.0 Field of View Image Height: the field of view height corresponding to the effective pixel of the sensor.

1.0 Field of View FOV: the field of view corresponding to the effective pixel of the sensor.

MIC Field of View Image Height: the field of view height to prevent assembly deviation is expanded by 1.0.

MIC Field of View FOV: the field of view corresponding to the MIC field of view image height.

Maximum Optical Radius: the maximum radius of the MIC field of view light reaching the lens surface.

The technical solutions of the present disclosure will be described in detail in five embodiments, the technical effect of the disclosure will not be achieved when the range of the above relational expression is exceeded.

### Embodiment 1

Table 1 and Table 2 show design data of the camera optical lens 10 according to Embodiment 1 of the present disclosure.

TABLE 1

| | R | d | | nd | | vd | |
|---|---|---|---|---|---|---|---|
| S1 | ∞ | d0= | −0.990 | | | | |
| R1 | 3.513 | d1= | 1.261 | nd1 | 1.4959 | v1 | 81.64 |
| R2 | 12.759 | d2= | 0.386 | | | | |
| R3 | 10.955 | d3= | 0.442 | nd2 | 1.6700 | v2 | 19.39 |
| R4 | 8.053 | d4= | 0.795 | | | | |
| R5 | 378.183 | d5= | 0.360 | nd3 | 1.6700 | v3 | 19.39 |
| R6 | 21.235 | d6= | 0.050 | | | | |
| R7 | 27.792 | d7= | 0.843 | nd4 | 1.5444 | v4 | 55.82 |
| R8 | −146.463 | d8= | 0.743 | | | | |
| R9 | 9.105 | d9= | 0.600 | nd5 | 1.5661 | v5 | 37.71 |
| R10 | 5.760 | d10= | 0.390 | | | | |
| R11 | 3.067 | d11= | 0.682 | nd6 | 1.5444 | v6 | 55.82 |
| R12 | 18.407 | d12= | 1.495 | | | | |
| R13 | −6.417 | d13= | 0.655 | nd7 | 1.5346 | v7 | 55.69 |
| R14 | 6.420 | d14= | 0.661 | | | | |
| R15 | ∞ | d15= | 0.310 | ndg | 1.5168 | vg | 64.17 |
| R16 | ∞ | d16= | 0.547 | | | | |

The meaning of each reference sign is as follows.
S1: aperture stop;
R: curvature radius at the center of the optical surface;
R1: central curvature radius of the object-side surface of the first lens L1;
R2: central curvature radius of the image-side surface of the first lens L1;
R3: central curvature radius of the object-side surface of the second lens L2;
R4: central curvature radius of the image-side surface of the second lens L2;
R5: central curvature radius of the object-side surface of the third lens L3;
R6: central curvature radius of the image-side surface of the third lens L3;
R7: central curvature radius of the object-side surface of the fourth lens L4;
R8: central curvature radius of the image-side surface of the fourth lens L4;
R9: central curvature radius of the object-side surface of the fifth lens L5;
R10: central curvature radius of the image-side surface of the fifth lens L5;
R11: central curvature radius of the object-side surface of the sixth lens L6;
R12: central curvature radius of the image-side surface of the sixth lens L6;
R13: central curvature radius of the object-side surface of the seventh lens L7;
R14: central curvature radius of the image-side surface of the seventh lens L7;
R15: central curvature radius of the object-side surface of the grating filter GF;
R16: central curvature radius of the image-side surface of the grating filter GF;
d: on-axis thickness of lenses, on-axis distance between lenses;
d0: on-axis distance from the aperture stop S1 to the object-side surface of the first lens L1;
d1: on-axis thickness of the first lens L1;
d2: on-axis distance from the image-side surface of the first lens L1 to the object-side surface of the second lens L2;
d3: on-axis thickness of the second lens L2;
d4: on-axis distance from the image-side surface of the second lens L2 to the object-side surface of the third lens L3;
d5: on-axis thickness of the third lens L3;
d6: on-axis distance from the image-side surface of the third lens L3 to the object-side surface of the fourth lens L4;
d7: on-axis thickness of the fourth lens L4;
d8: on-axis distance from the image-side surface of the fourth lens L4 to the object-side surface of the fifth lens L5;
d9: on-axis thickness of the fifth lens L5;
d10: on-axis distance from the image-side surface of the fifth lens L5 to the object-side surface of the sixth lens L6;
d11: on-axis thickness of the sixth lens L6;
d12: on-axis distance from the image-side surface of the sixth lens L6 to the object-side surface of the seventh lens L7;
d13: on-axis thickness of the seventh lens L7;
d14: on-axis distance from the image-side surface of the seventh lens L7 to the object-side surface of the grating filter GF;
d15: on-axis thickness of the grating filter GF;
d16: on-axis distance from the image-side surface of the grating filter GF to the image surface Si;
nd: refractive index of d line (the d line is green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the fifth lens L5;
nd6: refractive index of d line of the sixth lens L6;
nd7: refractive index of d line of the seventh lens L7;
ndg: refractive index of d line of the grating filter GF;
vd: abbe number;
v1: abbe number of the first lens L1;
v2: abbe number of the second lens L2;
v3: abbe number of the third lens L3;
v4: abbe number of the fourth lens L4;
v5: abbe number of the fifth lens L5;
v6: abbe number of the sixth lens L6;
v7: abbe number of the seventh lens L7; and
vg: abbe number of the grating filter GF.

Table 2 shows aspheric surface data of each lens in the camera optical lens 10 according to Embodiment 1 of the present disclosure.

TABLE 2

| | Conic | | | | | |
|---|---|---|---|---|---|---|
| | Coefficient | Aspheric Coefficient | | | | |
| | k | A4 | A6 | A8 | A10 | A12 |
| R1 | −1.2893E+00 | 3.5305E−03 | 1.6114E−04 | −6.7242E−06 | −1.2503E−05 | 8.2418E−06 |
| R2 | −8.9297E+01 | 2.2279E−03 | −1.1076E−03 | 3.0058E−04 | −5.7995E−05 | 5.9931E−06 |
| R3 | −3.4024E−01 | −6.0091E−03 | 7.5486E−04 | 2.3165E−04 | −1.0474E−04 | 2.8391E−05 |
| R4 | 4.4940E+00 | −4.3319E−03 | 2.2991E−04 | 6.5637E−04 | −3.3664E−04 | 9.8491E−05 |
| R5 | 7.5781E+01 | −4.0426E−03 | −6.0518E−03 | 4.5006E−03 | −2.5372E−03 | 8.3730E−04 |
| R6 | −4.4356E+01 | 2.3769E−03 | −1.3745E−02 | 8.6474E−03 | −3.4262E−03 | 8.5241E−04 |
| R7 | −5.4242E+01 | −1.3528E−03 | −1.0635E−02 | 5.9333E−03 | −1.7464E−03 | 2.9691E−04 |
| R8 | −9.9000E+01 | −1.1419E−02 | 1.4736E−03 | −9.3094E−04 | 3.0240E−04 | −5.0426E−05 |
| R9 | −6.8516E+01 | −1.7257E−02 | 8.6598E−03 | −3.4960E−03 | 9.3053E−04 | −1.7505E−04 |
| R10 | −3.7278E+01 | −4.0216E−02 | 1.2191E−02 | −3.0651E−03 | 5.9778E−04 | −8.8051E−05 |
| R11 | −1.8182E+00 | −1.6102E−02 | 3.7533E−03 | −1.0538E−03 | 1.6181E−04 | −1.8571E−05 |
| R12 | 2.7780E−01 | 2.2553E−02 | −4.8123E−03 | 3.6006E−04 | −4.2518E−06 | −1.2606E−06 |
| R13 | −1.5712E+00 | −1.5492E−02 | 2.0807E−03 | −6.6731E−05 | −7.1208E−06 | 8.8084E−07 |
| R14 | −1.7018E+01 | −1.2182E−02 | 1.6163E−03 | −1.4515E−04 | 5.3897E−06 | 5.9731E−07 |

| | Conic | | | | |
|---|---|---|---|---|---|
| | Coefficient | Aspheric Coefficient | | | |
| | k | A14 | A16 | A18 | A20 |
| R1 | −1.2893E+00 | −2.5273E−06 | 4.0378E−07 | −3.4342E−08 | 1.0926E−09 |
| R2 | −8.9297E+01 | −2.8131E−07 | −1.4360E−09 | 0.0000E+00 | 0.0000E+00 |
| R3 | −3.4024E−01 | −4.0944E−06 | 2.7405E−07 | 0.0000E+00 | 0.0000E+00 |
| R4 | 4.4940E+00 | −1.5212E−05 | 9.8591E−07 | 0.0000E+00 | 0.0000E+00 |
| R5 | 7.5781E+01 | −1.6435E−04 | 1.7406E−05 | −7.4822E−07 | 0.0000E+00 |
| R6 | −4.4356E+01 | −1.3133E−04 | 1.1389E−05 | −4.1168E−07 | 0.0000E+00 |
| R7 | −5.4242E+01 | −2.4235E−05 | −4.6685E−07 | 2.5140E−07 | −1.3755E−08 |
| R8 | 9.9000E+01 | 3.3520E−06 | 2.4270E−07 | −5.8922E−08 | 3.0379E−09 |
| R9 | −6.8516E+01 | 2.1946E−05 | −1.7082E−06 | 7.3623E−08 | −1.3238E−09 |
| R10 | −3.7278E+01 | 8.9014E−06 | −5.5513E−07 | 1.8927E−08 | −2.6883E−10 |
| R11 | −1.8182E+00 | 2.0568E−06 | −2.1433E−07 | 1.7216E−08 | −9.3142E−10 |
| R12 | 2.7780E−01 | 9.6077E−08 | −3.0388E−09 | 4.2840E−11 | −1.9020E−13 |
| R13 | −1.5712E+00 | −4.4680E−08 | 1.2863E−09 | −2.1856E−11 | 2.0482E−13 |
| R14 | −1.7018E+01 | −1.2745E−07 | 1.1668E−08 | −6.4632E−10 | 2.3035E−11 |

For convenience, the aspheric surface of each lens surface uses the aspheric surface shown in a following formula (1). However, the present disclosure is not limited to the aspheric polynomial form shown in formula (1).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 1 )$$

Where, k is a conic coefficient, A4, A6, A8, A10, A12, A14, A16, A18, and A20 are aspheric coefficients, c is a curvature at a center of an optical surface, r is a vertical distance between a point on an aspheric curve and an optical axis, and z is an aspheric depth (a vertical distance between a point on the aspheric surface and the optical axis, where r is a distance from the point on the aspheric surface to the optical axis, and a vertical distance between the point on the aspheric surface and a tangent plane tangent to a vertex on the aspheric optical axis).

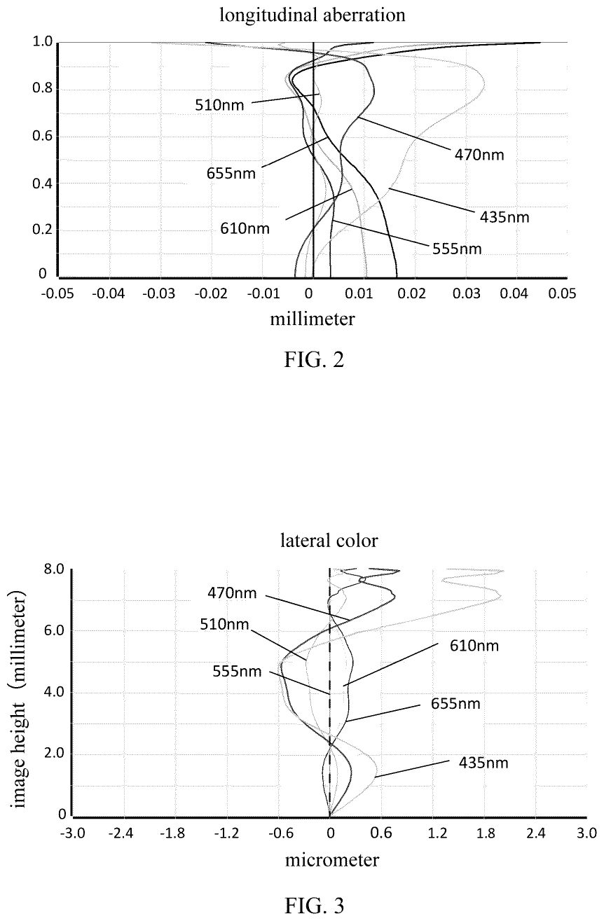

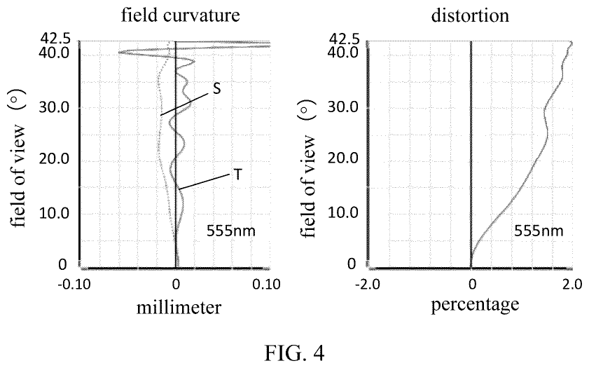

FIG. 2 and FIG. 3 respectively show longitudinal aberration and lateral color of light with wavelengths of 655 nm, 610 nm, 555 nm, 510 nm, 470 nm, and 435 nm after passing through the camera optical lens 10 according to Embodiment 1. FIG. 4 shows field curvature and distortion of light with a wavelength of 555 nm after passing through the camera optical lens 10 according to Embodiment 1, the field curvature S in FIG. 4 is a field curvature in the sagittal direction, and T is a field curvature in the meridian direction.

In this embodiment, the entrance pupil diameter ENPD of the camera optical lens 10 is 5.067 mm, the 1.0 field of view image height IH is 8.000 mm, the MIC field of view image height is 8.290 mm, the 1.0 field of view FOV is 85.00°, the MIC field of view FOV is 87.4°. The camera optical lens 10 meets the design requirements of small aberration, high light flux, good processability, low assembling sensitivity, wide-angle, ultra-thin and has good optical characteristics.

It may be understood that the 1.0 field of view image height refers to half of the diagonal length of an effective pixel area of the sensor; the MIC field of view image height refers to a field of view height that is expanded from the 1.0 field of view image height and is used to prevent assembly deviation; the FOV in the diagonal direction of the 1.0 field of view refers to the field of view corresponding to the effective pixel area of the sensor; and the FOV in the diagonal direction of the MIC field of view refers to a field of view corresponding to the MIC field of view image height.

### Embodiment 2

The meaning of the reference signs of Embodiment 2 is the same as that of Embodiment 1.

FIG. 5 shows a camera optical lens 20 according to Embodiment 2 of the present disclosure.

Table 3 and Table 4 show design data of the camera optical lens 20 according to Embodiment 2 of the present disclosure.

TABLE 3

| | R | d | | nd | | vd | |
|---|---|---|---|---|---|---|---|
| S1 | ∞ | d0= | −0.090 | | | | |
| R1 | 3.472 | d1= | 1.414 | nd1 | 1.4959 | v1 | 81.65 |
| R2 | 10.621 | d2= | 0.345 | | | | |
| R3 | 9.236 | d3= | 0.349 | nd2 | 1.6700 | v2 | 19.39 |
| R4 | 7.333 | d4= | 0.600 | | | | |
| R5 | 46.241 | d5= | 0.351 | nd3 | 1.6700 | v3 | 19.39 |
| R6 | 17.919 | d6= | 0.090 | | | | |
| R7 | 17.681 | d7= | 0.784 | nd4 | 1.5444 | v4 | 55.82 |
| R8 | −101.816 | d8= | 0.905 | | | | |
| R9 | −8.495 | d9= | 0.604 | nd5 | 1.5661 | v5 | 37.71 |
| R10 | 26.468 | d10= | 0.052 | | | | |
| R11 | 2.368 | d11= | 0.767 | nd6 | 1.5346 | v6 | 55.69 |
| R12 | 6.995 | d12= | 1.186 | | | | |
| R13 | 4.894 | d13= | 0.636 | nd7 | 1.5346 | v7 | 55.69 |
| R14 | 2.388 | d14= | 1.115 | | | | |
| R15 | ∞ | d15= | 0.310 | ndg | 1.5168 | vg | 64.17 |
| R16 | ∞ | d16= | 0.691 | | | | |

Table 4 shows aspheric surface data of each lens in the camera optical lens 20 according to Embodiment 2 of the present disclosure.

TABLE 4

| | Conic | | | | | |
|---|---|---|---|---|---|---|
| | Coefficient | Aspheric Coefficient | | | | |
| | k | A4 | A6 | A8 | A10 | A12 |
| R1 | 3.9108E−02 | 2.9588E−03 | −7.0759E−03 | 7.3993E−03 | −4.3936E−03 | 1.5784E−03 |
| R2 | 1.4384E+00 | −1.3320E−03 | −5.3740E−03 | 5.9864E−03 | −3.7839E−03 | 1.4640E−03 |
| R3 | −5.1254E−01 | −5.5340E−03 | −3.6184E−03 | 4.7766E−03 | −2.9949E−03 | 1.2265E−03 |
| R4 | −9.1475E−02 | 1.6023E−05 | −1.1314E−02 | 1.5908E−02 | −1.2366E−02 | 5.9951E−03 |
| R5 | 9.7886E+01 | −7.6047E−03 | 6.5449E−03 | −9.1483E−03 | 5.7133E−03 | −2.1398E−03 |
| R6 | 1.1659E+01 | −5.3066E−03 | 7.8360E−03 | −1.6299E−02 | 1.3462E−02 | −6.3099E−03 |
| R7 | −8.4469E−01 | −2.5614E−03 | −5.0938E−03 | −2.9931E−04 | 2.1554E−03 | −1.2437E−03 |
| R8 | 1.0117E+03 | −2.3989E−03 | −1.2762E−03 | −1.8782E−03 | 1.4219E−03 | −4.4551E−04 |
| R9 | −1.2442E+00 | 2.7773E−02 | −1.4725E−02 | 2.8284E−03 | 1.5735E−03 | −1.3760E−03 |
| R10 | −2.8692E+01 | −3.1516E−02 | −1.6832E−03 | 6.9268E−03 | −3.7303E−03 | 1.1304E−03 |
| R11 | −6.2557E+00 | 7.3876E−03 | −6.2927E−03 | 1.9248E−03 | −5.5120E−04 | 1.1625E−04 |
| R12 | −1.1420E+00 | 3.0945E−02 | −1.3470E−02 | 2.8651E−03 | −4.3058E−04 | 4.6190E−05 |
| R13 | −1.0994E+00 | −5.7763E−02 | 9.8890E−03 | −1.1842E−03 | 8.5073E−05 | −2.5345E−07 |
| R14 | −9.9551E−01 | −6.7599E−02 | 1.6207E−02 | −3.3868E−03 | 5.5517E−04 | −6.9008E−05 |
| | k | A14 | A16 | A18 | A20 | A22 |
| R1 | 3.9108E−02 | −3.5112E−04 | 4.7292E−05 | −3.5370E−06 | 1.1270E−07 | 0.0000E+00 |
| R2 | 1.4384E+00 | −3.5237E−04 | 5.1568E−05 | −4.2122E−06 | 1.4750E−07 | 0.0000E+00 |
| R3 | −5.1254E−01 | −3.1441E−04 | 4.8777E−05 | −4.1949E−06 | 1.5408E−07 | 0.0000E+00 |
| R4 | −9.1475E−02 | −1.8120E−03 | 3.3364E−04 | −3.4334E−05 | 1.5194E−06 | 0.0000E+00 |
| R5 | 9.7886E+01 | 4.5417E−04 | −4.4438E−05 | 1.4399E−07 | 2.0321E−07 | 0.0000E+00 |
| R6 | 1.1659E+01 | 1.7606E−03 | −2.8677E−04 | 2.5013E−05 | −8.9587E−07 | 0.0000E+00 |
| R7 | −8.4469E−01 | 3.3938E−04 | −4.6449E−05 | 2.6788E−06 | −2.3601E−08 | 0.0000E+00 |
| R8 | 1.0117E+03 | 6.9637E−05 | −4.4468E−06 | −7.7642E−08 | 1.6128E−08 | 0.0000E+00 |
| R9 | −1.2442E+00 | 4.4136E−04 | −5.7563E−05 | −5.5874E−06 | 3.6154E−06 | −6.8212E−07 |
| R10 | −2.8692E+01 | −2.2069E−04 | 2.8278E−05 | −2.2874E−06 | 9.9763E−08 | −3.1051E−10 |
| R11 | −6.2557E+00 | −1.6364E−05 | 1.4730E−06 | −7.9914E−08 | 2.2061E−09 | −5.6909E−12 |
| R12 | −1.1420E+00 | −3.1767E−06 | 7.0770E−08 | 1.1345E−08 | −1.4851E−09 | 9.2104E−11 |
| R13 | −1.0994E+00 | −6.5136E−07 | 7.4662E−08 | −4.6699E−09 | 1.8907E−10 | −5.1262E−12 |
| R14 | −9.9551E−01 | 6.3897E−06 | −4.3580E−07 | 2.1747E−08 | −7.8814E−10 | 2.0460E−11 |

| | k | A24 | A26 | A28 | A30 | / |
|---|---|---|---|---|---|---|
| R1 | 3.9108E−02 | 0.0000E+00 | 0.0000E+00 | 0.0000E+00 | 0.0000E+00 | / |
| R2 | 1.4384E+00 | 0.0000E+00 | 0.0000E+00 | 0.0000E+00 | 0.0000E+00 | / |
| R3 | −5.1254E−01 | 0.0000E+00 | 0.0000E+00 | 0.0000E+00 | 0.0000E+00 | / |
| R4 | −9.1475E−02 | 0.0000E+00 | 0.0000E+00 | 0.0000E+00 | 0.0000E+00 | / |
| R5 | 9.7886E+01 | 0.0000E+00 | 0.0000E+00 | 0.0000E+00 | 0.0000E+00 | / |
| R6 | 1.1659E+01 | 0.0000E+00 | 0.0000E+00 | 0.0000E+00 | 0.0000E+00 | / |
| R7 | −8.4469E−01 | 0.0000E+00 | 0.0000E+00 | 0.0000E+00 | 0.0000E+00 | / |
| R8 | 1.0117E+03 | 0.0000E+00 | 0.0000E+00 | 0.0000E+00 | 0.0000E+00 | / |
| R9 | −1.2442E+00 | 7.1732E−08 | −4.4705E−09 | 1.5434E−10 | −2.2709E−12 | / |
| R10 | −2.8692E+01 | −2.1304E−10 | 1.1329E−11 | −2.5378E−13 | 2.1527E−15 | / |
| R11 | −6.2557E+00 | −1.0998E−12 | 5.2099E−15 | 7.9315E−16 | −1.3185E−17 | / |
| R12 | −1.1420E+00 | −3.4777E−12 | 8.1476E−14 | −1.0963E−15 | 6.5148E−18 | / |
| R13 | −1.0994E+00 | 9.1400E−14 | −1.0000E−15 | 5.6762E−18 | −9.9560E−21 | / |
| R14 | −9.9551E−01 | −3.7029E−13 | 4.4349E−15 | −3.1591E−17 | 1.0137E−19 | / |

For convenience, the aspheric surface of each lens surface uses the aspheric surface shown in a following formula (2). However, the present disclosure is not limited to the aspheric polynomial form shown in formula (2).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 2 )$$

Where, k is a conic coefficient, A4, A6, A8, A10, A12, A14, A16, A18, A20, A22, A24, A26, A28 and A30 are aspheric coefficients, c is a curvature at a center of an optical surface, r is a vertical distance between a point on an aspheric curve and an optical axis, and z is an aspheric depth (a vertical distance between a point on the aspheric surface and the optical axis, where r is a distance from the point on the aspheric surface to the optical axis, and a vertical distance between the point on the aspheric surface and a tangent plane tangent to a vertex on the aspheric optical axis).

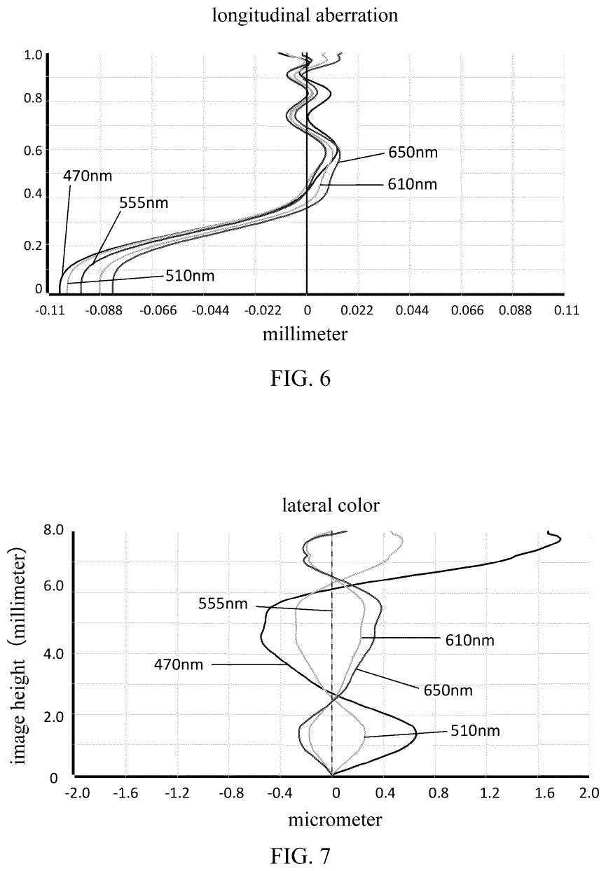

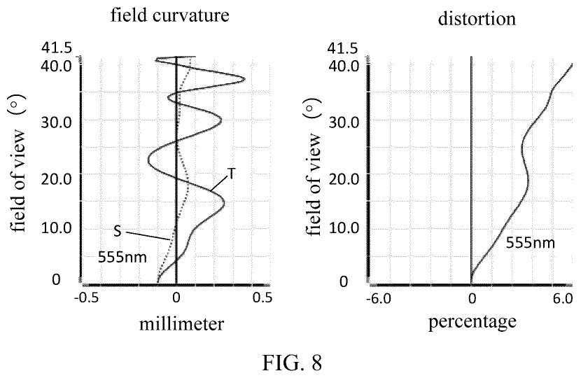

FIG. 6 and FIG. 7 respectively show longitudinal aberration and lateral color of light with wavelengths of 650 nm, 610 nm, 555 nm, 510 nm, and 470 nm after passing through the camera optical lens 20 according to Embodiment 2. FIG. 8 shows field curvature and distortion of light with a wavelength of 555 nm after passing through the camera optical lens 20 according to Embodiment 2. The field curvature S in FIG. 8 is the field curvature in the sagittal direction, and T is the field curvature in the meridian direction.

In this embodiment, the entrance pupil diameter ENPD of the camera optical lens 20 is 5.077 mm, the 1.0 field of view image height IH is 8.000 mm, the MIC field of view image height is 8.290 mm, the 1.0 field of view FOV is 83.00°, the MIC field of view FOV is 84.97°. The camera optical lens 20 meets the design requirements of small aberration, high light flux, good processability, low assembling sensitivity, wide-angle, ultra-thin and has good optical characteristics.

### Embodiment 3

The meaning of the reference signs of Embodiment 3 is the same as that of Embodiment 1.

FIG. 9 shows a camera optical lens 30 according to Embodiment 3 of the present disclosure.

Table 5 and Table 6 show design data of the camera optical lens 30 according to the Embodiment 3 of the present disclosure.

TABLE 5

| | R | d | | nd | | vd | |
|---|---|---|---|---|---|---|---|
| S1 | ∞ | d0= | −0.090 | | | | |
| R1 | 3.439 | d1= | 1.221 | nd1 | 1.4959 | v1 | 81.64 |
| R2 | 10.745 | d2= | 0.419 | | | | |
| R3 | 10.226 | d3= | 0.350 | nd2 | 1.6700 | v2 | 19.39 |
| R4 | 8.251 | d4= | 0.766 | | | | |
| R5 | −257.263 | d5= | 0.369 | nd3 | 1.6700 | v3 | 19.39 |
| R6 | 22.930 | d6= | 0.040 | | | | |
| R7 | 29.939 | d7= | 0.906 | nd4 | 1.5444 | v4 | 55.82 |
| R8 | −5540.257 | d8= | 0.691 | | | | |
| R9 | 7.065 | d9= | 0.622 | nd5 | 1.5661 | v5 | 37.71 |
| R10 | 4.570 | d10= | 0.392 | | | | |
| R11 | 3.276 | d11= | 0.667 | nd6 | 1.5444 | v6 | 55.82 |
| R12 | −20.441 | d12= | 1.114 | | | | |
| R13 | −9.846 | d13= | 0.600 | nd7 | 1.5346 | v7 | 55.69 |
| R14 | 3.983 | d14= | 1.151 | | | | |
| R15 | ∞ | d15= | 0.310 | ndg | 1.5168 | vg | 64.17 |
| R16 | ∞ | d16= | 0.533 | | | | |

Table 6 shows aspheric surface data of each lens in the camera optical lens 30 according to Embodiment 3 of the present disclosure, aspheric surface of each lens surface uses aspheric surface shown in the above formula (1). However, the present disclosure is not limited to the aspheric polynomial form represented by the formula (1).

TABLE 6

| | Conic | | | | | |
|---|---|---|---|---|---|---|
| | Coefficient | Aspheric Coefficient | | | | |
| | k | A4 | A6 | A8 | A10 | A12 |
| R1 | −1.3795E+00 | 3.9635E−03 | 6.0717E−04 | −6.2490E−04 | 4.6424E−04 | −2.0880E−04 |
| R2 | −4.6368E+01 | 7.8762E−04 | −5.9303E−04 | 1.2622E−05 | 5.5579E−05 | −2.1952E−05 |
| R3 | −4.6340E+00 | −9.1683E−03 | 1.5984E−03 | −2.5245E−04 | 2.3047E−04 | −7.1746E−05 |
| R4 | 5.7545E+00 | −7.7362E−03 | 6.8140E−04 | 7.1424E−04 | −3.5109E−04 | 1.2242E−04 |
| R5 | 4.9987E+01 | −3.1164E−03 | −6.2300E−03 | 2.9102E−03 | −1.1317E−03 | 2.1164E−04 |
| R6 | −3.6475E+01 | 5.7756E−03 | −1.1545E−02 | 3.9018E−03 | −6.8831E−04 | 4.7700E−05 |
| R7 | 9.6458E+00 | −1.5933E−03 | −3.8752E−03 | −2.0551E−03 | 2.5432E−03 | −9.7692E−04 |
| R8 | 9.9000E+01 | −1.7502E−02 | 6.1064E−03 | −3.7997E−03 | 1.4734E−03 | −3.6469E−04 |
| R9 | −5.6614E+01 | −2.3381E−02 | 1.1023E−02 | −4.2308E−03 | 1.0297E−03 | −1.7684E−04 |
| R10 | −2.6841E+01 | −4.4536E−02 | 9.7827E−03 | −1.5193E−03 | 1.1730E−04 | 5.5319E−07 |
| R11 | −1.6796E+00 | −9.4789E−03 | −2.8495E−05 | 1.7973E−04 | −1.5448E−04 | 3.7292E−05 |
| R12 | −7.8329E+01 | 3.5725E−02 | −7.1606E−03 | 5.6901E−04 | −1.4054E−05 | −7.5624E−07 |
| R13 | −2.5595E−01 | −2.2616E−02 | 2.5738E−03 | 1.3169E−04 | −4.4827E−05 | 3.9183E−06 |
| R14 | −8.4848E+00 | −2.0232E−02 | 3.8330E−03 | −5.5914E−04 | 6.7562E−05 | −6.8344E−06 |

| | Conic | | | | |
|---|---|---|---|---|---|
| | Coefficient | Aspheric Coefficient | | | |
| | k | A14 | A16 | A18 | A20 |
| R1 | −1.3795E+00 | 5.7392E−05 | −9.4917E−06 | 8.6609E−07 | −3.3779E−08 |
| R2 | −4.6368E+01 | 3.6102E−06 | −2.3728E−07 | 0.0000E+00 | 0.0000E+00 |
| R3 | −4.6340E+00 | 1.0475E−05 | −5.5369E−07 | 0.0000E+00 | 0.0000E+00 |
| R4 | 5.7545E+00 | −2.3364E−05 | 1.8951E−06 | 0.0000E+00 | 0.0000E+00 |
| R5 | 4.9987E+01 | −6.9158E−06 | −4.0176E−06 | 4.9072E−07 | 0.0000E+00 |
| R6 | −3.6475E+01 | 0.0000E+00 | 0.0000E+00 | 0.0000E+00 | 0.0000E+00 |
| R7 | 9.6458E+00 | 1.9817E−04 | −2.3028E−05 | 1.4634E−06 | −3.9728E−08 |
| R8 | 9.9000E+01 | 5.9334E−05 | −6.0960E−06 | 3.5129E−07 | −8.4681E−09 |
| R9 | −5.6614E+01 | 2.1321E−05 | −1.6639E−06 | 7.2965E−08 | −1.3337E−09 |
| R10 | −2.6841E+01 | −6.8312E−07 | 4.0317E−08 | −7.8771E−10 | 1.3420E−12 |
| R11 | −1.6796E+00 | −4.6743E−06 | 3.4697E−07 | −1.5298E−08 | 3.6926E−10 |
| R12 | −7.8329E+01 | 5.0060E−08 | −3.0561E−10 | −3.4890E−11 | 6.5541E−13 |
| R13 | −2.5595E−01 | −1.8464E−07 | 5.2495E−09 | −9.0399E−11 | 8.7226E−13 |
| R14 | −8.4848E+00 | 5.3567E−07 | −3.0531E−08 | 1.2296E−09 | −3.4423E−11 |

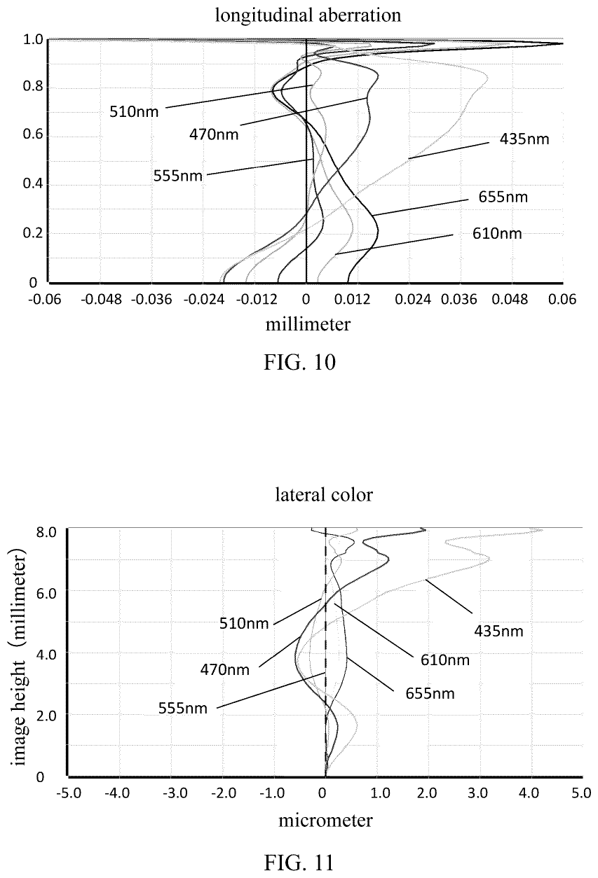

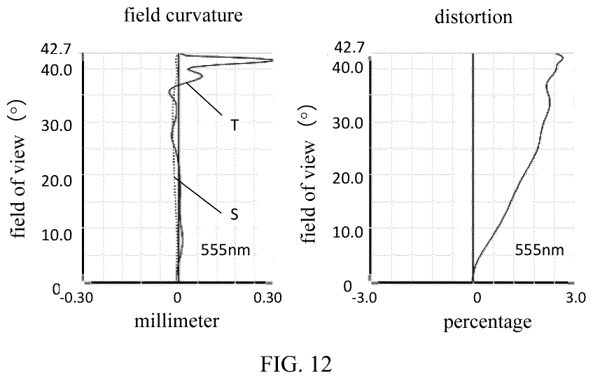

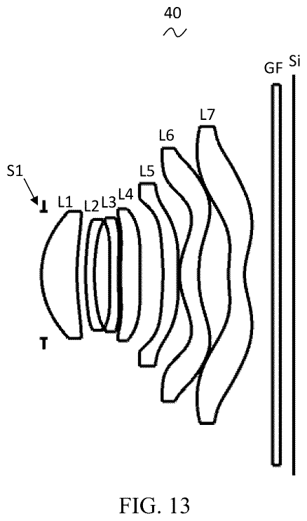

FIG. 10 and FIG. 11 respectively show longitudinal aberration and lateral color of light with wavelengths of 655 nm, 610 nm, 555 nm, 510 nm, 470 nm, and 435 nm after passing through the camera optical lens 30 according to Embodiment 3. FIG. 12 shows field curvature and distortion of light with a wavelength of 555 nm after passing through the camera optical lens 30 according to Embodiment 3. The field curvature S in FIG. 12 is the field curvature in the sagittal direction, and T is the field curvature in the meridian direction.

In this embodiment, the entrance pupil diameter ENPD of the camera optical lens 30 is 5.062 mm, the 1.0 field of view image height IH is 8.000 mm, the MIC field of view image height is 8.290 mm, the 1.0 field of view FOV is 85.40°, the MIC field of view FOV is 87.59°. The camera optical lens 30 meets the design requirements of small aberration, high light flux, good processability, low assembling sensitivity, wide-angle, ultra-thin and has good optical characteristics.

### Embodiment 4

The meaning of the reference signs of Embodiment 2 is the same as that of Embodiment 1.

Table 7 and Table 8 show design data of the camera optical lens 40 according to Embodiment 4 of the present disclosure.

TABLE 7

| | R | d | | nd | | vd | |
|---|---|---|---|---|---|---|---|
| S1 | ∞ | d0= | −0.090 | | | | |
| R1 | 3.457 | d1= | 1.414 | nd1 | 1.4959 | v1 | 81.65 |
| R2 | 9.881 | d2= | 0.345 | | | | |
| R3 | 9.700 | d3= | 0.349 | nd2 | 1.6700 | v2 | 19.39 |
| R4 | 7.771 | d4= | 0.600 | | | | |
| R5 | 31.799 | d5= | 0.351 | nd3 | 1.6700 | v3 | 19.39 |
| R6 | 15.254 | d6= | 0.090 | | | | |
| R7 | 17.101 | d7= | 0.784 | nd4 | 1.5444 | v4 | 55.82 |
| R8 | −103.160 | d8= | 0.905 | | | | |
| R9 | −8.538 | d9= | 0.604 | nd5 | 1.5661 | v5 | 37.71 |
| R10 | 28.498 | d10= | 0.052 | | | | |
| R11 | 2.395 | d11= | 0.767 | nd6 | 1.5346 | v6 | 55.69 |
| R12 | 6.888 | d12= | 1.186 | | | | |
| R13 | 4.993 | d13= | 0.636 | nd7 | 1.5346 | v7 | 55.69 |
| R14 | 2.395 | d14= | 1.115 | | | | |
| R15 | ∞ | d15= | 0.310 | ndg | 1.5168 | vg | 64.17 |
| R16 | ∞ | d16= | 0.533 | | | | |

Table 8 shows aspheric surface data of each lens in the camera optical lens 40 according to Embodiment 4 of the present disclosure, aspheric surface of each lens surface uses aspheric surface shown in the above formula (2). However, the present disclosure is not limited to the aspheric polynomial form represented by the formula (2).

TABLE 8

| | Conic | | | | | |
|---|---|---|---|---|---|---|
| | Coefficient | Aspheric Coefficient | | | | |
| | k | A4 | A6 | A8 | A10 | A12 |
| R1 | 0.0000E+00 | 2.8930E−03 | −6.7072E−03 | 7.2002E−03 | −4.4400E−03 | 1.6548E−03 |
| R2 | 0.0000E+00 | −6.9167E−04 | −6.1840E−03 | 6.3387E−03 | −3.9220E−03 | 1.5283E−03 |
| R3 | 0.0000E+00 | −5.3742E−03 | −4.1540E−03 | 5.1888E−03 | −2.9979E−03 | 1.1334E−03 |
| R4 | 0.0000E+00 | −1.2611E−03 | −8.6298E−03 | 1.2939E−02 | −1.0515E−02 | 5.4697E−03 |
| R5 | 0.0000E+00 | −5.3772E−03 | 1.6618E−05 | −2.9517E−03 | 2.2434E−03 | −9.6378E−04 |
| R6 | 0.0000E+00 | −1.4440E−03 | 3.8437E−05 | −9.2895E−03 | 9.7438E−03 | −5.2526E−03 |
| R7 | 0.0000E+00 | 2.4792E−03 | −1.1227E−02 | 4.7130E−03 | −6.0636E−04 | −3.3843E−04 |
| R8 | 0.0000E+00 | −9.9261E−04 | −2.9100E−03 | −5.3556E−04 | 8.5346E−04 | −3.5468E−04 |
| R9 | −1.0000E+00 | 2.6177E−02 | −1.1365E−02 | 6.4553E−04 | 2.3321E−03 | −1.5321E−03 |
| R10 | −1.0000E+00 | −3.3066E−02 | −4.9284E−04 | 6.5174E−03 | −3.6588E−03 | 1.1243E−03 |
| R11 | −6.0000E+00 | 5.0635E−03 | −5.3391E−03 | 1.7041E−03 | −5.2520E−04 | 1.1500E−04 |
| R12 | −1.0000E+00 | 3.1821E−02 | −1.3721E−02 | 2.8997E−03 | −4.3372E−04 | 4.6373E−05 |
| R13 | −1.0000E+00 | −5.9057E−02 | 1.0294E−02 | −1.2382E−03 | 8.8635E−05 | −3.5567E−07 |
| R14 | −1.0000E+00 | −6.9201E−02 | 1.6450E−02 | −3.4017E−03 | 5.5547E−04 | −6.9006E−05 |
| | k | A14 | A16 | A18 | A20 | A22 |
| R1 | 0.0000E+00 | −3.7992E−04 | 5.2451E−05 | −3.9932E−06 | 1.2875E−07 | 0.0000E+00 |
| R2 | 0.0000E+00 | −3.7466E−04 | 5.5845E−05 | −4.6141E−06 | 1.6181E−07 | 0.0000E+00 |
| R3 | 0.0000E+00 | −2.6612E−04 | 3.6357E−05 | −2.5287E−06 | 6.3112E−08 | 0.0000E+00 |
| R4 | 0.0000E+00 | −1.7916E−03 | 3.5838E−04 | −4.0107E−05 | 1.9344E−06 | 0.0000E+00 |
| R5 | 0.0000E+00 | 2.3423E−04 | −2.7928E−05 | 6.8853E−07 | 1.0479E−07 | 0.0000E+00 |
| R6 | 0.0000E+00 | 1.6656E−03 | −3.1141E−04 | 3.1723E−05 | −1.3545E−06 | 0.0000E+00 |
| R7 | 0.0000E+00 | 1.9408E−04 | −4.3539E−05 | 4.6716E−06 | −1.9548E−07 | 0.0000E+00 |
| R8 | 0.0000E+00 | 7.8793E−05 | −9.8273E−06 | 6.2591E−07 | −1.4988E−08 | 0.0000E+00 |
| R9 | −1.0000E+00 | 4.5932E−04 | −5.8155E−05 | −5.6955E−06 | 3.6198E−06 | −6.7957E−07 |
| R10 | −1.0000E+00 | −2.2043E−04 | 2.8258E−05 | −2.2849E−06 | 9.9743E−08 | −3.2830E−10 |
| R11 | −6.0000E+00 | −1.6380E−05 | 1.4757E−06 | −7.9845E−08 | 2.1953E−09 | −5.5241E−12 |
| R12 | −1.0000E+00 | −3.1841E−06 | 7.1361E−08 | 1.1284E−08 | −1.4823E−09 | 9.2105E−11 |
| R13 | −1.0000E+00 | −6.5153E−07 | 7.4722E−08 | −4.6700E−09 | 1.8905E−10 | −5.1264E−12 |
| R14 | −1.0000E+00 | 6.3898E−06 | −4.3583E−07 | 2.1748E−08 | −7.8814E−10 | 2.0460E−11 |

| | Conic | | | | | |
|---|---|---|---|---|---|---|
| | Coefficient | Aspheric Coefficient | | | | |
| | k | A24 | A26 | A28 | A30 | / |
| R1 | 0.0000E+00 | 0.0000E+00 | 0.0000E+00 | 0.0000E+00 | 0.0000E+00 | / |
| R2 | 0.0000E+00 | 0.0000E+00 | 0.0000E+00 | 0.0000E+00 | 0.0000E+00 | / |
| R3 | 0.0000E+00 | 0.0000E+00 | 0.0000E+00 | 0.0000E+00 | 0.0000E+00 | / |
| R4 | 0.0000E+00 | 0.0000E+00 | 0.0000E+00 | 0.0000E+00 | 0.0000E+00 | / |
| R5 | 0.0000E+00 | 0.0000E+00 | 0.0000E+00 | 0.0000E+00 | 0.0000E+00 | / |
| R6 | 0.0000E+00 | 0.0000E+00 | 0.0000E+00 | 0.0000E+00 | 0.0000E+00 | / |
| R7 | 0.0000E+00 | 0.0000E+00 | 0.0000E+00 | 0.0000E+00 | 0.0000E+00 | / |
| R8 | 0.0000E+00 | 0.0000E+00 | 0.0000E+00 | 0.0000E+00 | 0.0000E+00 | / |
| R9 | −1.0000E+00 | 7.1390E−08 | −4.4638E−09 | 1.5564E−10 | −2.3377E−12 | / |
| R10 | −1.0000E+00 | −2.1154E−10 | 1.1263E−11 | −2.5145E−13 | 2.1040E−15 | / |
| R11 | −6.0000E+00 | −1.0887E−12 | 4.7379E−15 | 7.9993E−16 | −1.3225E−17 | / |
| R12 | −1.0000E+00 | −3.4813E−12 | 8.1510E−14 | −1.0932E−15 | 6.4502E−18 | / |
| R13 | −1.0000E+00 | 9.1385E−14 | −9.9960E−16 | 5.6897E−18 | −1.0269E−20 | / |
| R14 | −1.0000E+00 | −3.7028E−13 | 4.4347E−15 | −3.1589E−17 | 1.0135E−19 | / |

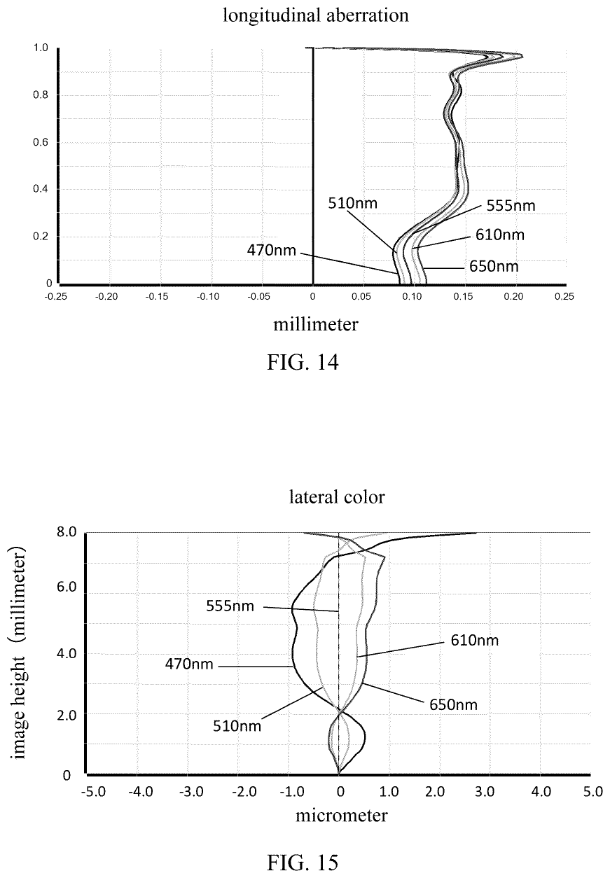

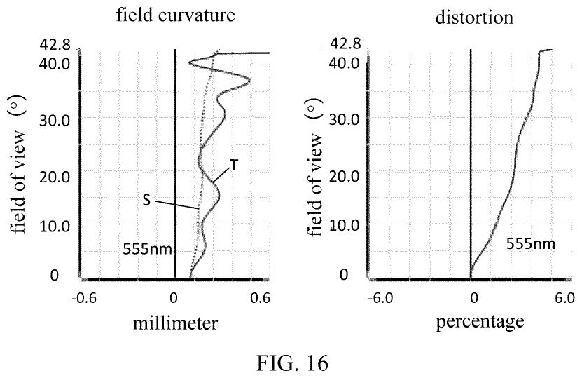

FIG. 14 and FIG. 15 respectively show longitudinal aberration and lateral color of light with wavelengths of 650 nm, 610 nm, 555 nm, 510 nm, and 470 nm after passing through the camera optical lens 40 according to Embodiment 4. FIG. 16 shows field curvature and distortion of light with a wavelength of 555 nm after passing through the camera optical lens 40 according to Embodiment 4, the field curvature S in FIG. 16 is a field curvature in the sagittal direction, and T is a field curvature in the meridian direction.

In this embodiment, the entrance pupil diameter ENPD of the camera optical lens 40 is 5.136 mm, the 1.0 field of view image height IH is 8.000 mm, the MIC field of view image height is 8.250 mm, the 1.0 field of view FOV is 85.58°, the MIC field of view FOV is 87.71°. The camera optical lens 40 meets the design requirements of small aberration, high light flux, good processability, low assembling sensitivity, wide-angle, ultra-thin and has good optical characteristics.

### Embodiment 5

The meaning of the reference signs of Embodiment 5 is the same as that of Embodiment 1.

FIG. 17 shows a camera optical lens 50 according to Embodiment 5 of the present disclosure.

Table 9 and Table 10 show design data of the camera optical lens 50 according to Embodiment 5 of the present disclosure.

TABLE 9

| | R | d | | nd | | vd | |
|---|---|---|---|---|---|---|---|
| S1 | ∞ | d0= | −0.079 | | | | |
| R1 | 3.430 | d1= | 1.202 | nd1 | 1.4959 | v1 | 81.64 |
| R2 | 10.307 | d2= | 0.406 | | | | |
| R3 | 14.019 | d3= | 0.364 | nd2 | 1.6700 | v2 | 19.39 |
| R4 | 9.738 | d4= | 0.661 | | | | |
| R5 | 19.933 | d5= | 0.331 | nd3 | 1.6700 | v3 | 19.39 |
| R6 | 9.612 | d6= | 0.087 | | | | |
| R7 | 32.237 | d7= | 1.122 | nd4 | 1.5444 | v4 | 55.82 |
| R8 | −23.099 | d8= | 0.863 | | | | |
| R9 | −7.423 | d9= | 0.459 | nd5 | 1.5661 | v5 | 37.71 |
| R10 | 24.758 | d10= | 0.024 | | | | |
| R11 | 1.944 | d11= | 0.600 | nd6 | 1.5346 | v6 | 55.69 |
| R12 | 5.513 | d12= | 1.727 | | | | |
| R13 | 5.777 | d13= | 0.367 | nd7 | 1.5346 | v7 | 55.69 |
| R14 | 2.435 | d14= | 1.115 | | | | |
| R15 | ∞ | d15= | 0.310 | ndg | 1.5168 | vg | 64.17 |
| R16 | ∞ | d16= | 0.612 | | | | |

Table 10 shows aspheric surface data of each lens in the camera optical lens 50 according to Embodiment 5 of the present disclosure, aspheric surface of each lens surface uses aspheric surface shown in the above formula (1). However, the present disclosure is not limited to the aspheric polynomial form represented by the formula (1).

TABLE 10

| | Conic | | | | | |
|---|---|---|---|---|---|---|
| | Coefficient | Aspheric Coefficient | | | | |
| | k | A4 | A6 | A8 | A10 | A12 |
| R1 | 1.6844E−01 | −4.4328E−04 | 3.4711E−04 | −3.6324E−04 | 2.2516E−04 | −8.6777E−05 |
| R2 | 6.6432E+00 | −3.3613E−03 | 2.8474E−04 | −3.1295E−04 | 2.5614E−04 | −1.2821E−04 |
| R3 | 1.6152E+00 | −7.1485E−03 | 7.3410E−04 | 4.5752E−04 | −2.6300E−04 | 1.1776E−04 |
| R4 | −2.3141E−01 | −5.6151E−03 | 1.3919E−03 | −4.0323E−04 | 3.9621E−04 | −1.9522E−04 |
| R5 | −7.1176E+01 | −1.2497E−02 | −3.5611E−03 | 2.9529E−03 | −2.1499E−03 | 9.0039E−04 |
| R6 | −5.6865E+01 | −3.5475E−03 | −1.0175E−02 | 7.1074E−03 | −3.6451E−03 | 1.2043E−03 |
| R7 | −9.8980E+01 | −4.5687E−03 | −9.6287E−03 | 9.1085E−03 | −6.2330E−03 | 3.2472E−03 |
| R8 | 1.0783E+01 | −5.3770E−03 | −1.2421E−03 | −5.8877E−04 | 8.3120E−04 | −4.5469E−04 |
| R9 | −3.1642E+00 | 4.9117E−02 | −4.5372E−02 | 3.5341E−02 | −2.0947E−02 | 8.9666E−03 |
| R10 | 3.6331E+01 | −7.3166E−02 | 3.3160E−02 | −7.4602E−03 | −7.9582E−04 | 1.2332E−03 |
| R11 | −6.3315E+00 | 8.5141E−03 | −2.3466E−03 | −2.0097E−03 | 1.4199E−03 | −4.7474E−04 |
| R12 | −1.0000E+00 | 5.9982E−02 | −3.9176E−02 | 1.4302E−02 | −3.6452E−03 | 6.6719E−04 |
| R13 | −1.4876E+00 | −6.0982E−02 | 1.1112E−02 | −1.4993E−03 | 1.0778E−04 | 1.0568E−05 |
| R14 | −1.0066E+00 | −7.0645E−02 | 1.7232E−02 | −3.8112E−03 | 6.9979E−04 | −1.0189E−04 |

| | Conic | | | | |
|---|---|---|---|---|---|
| | Coefficient | Aspheric Coefficient | | | |
| | k | A14 | A16 | A18 | A20 |
| R1 | 1.6844E−01 | 2.0809E−05 | −3.0295E−06 | 2.4528E−07 | −8.4804E−09 |
| R2 | 6.6432E+00 | 4.1827E−05 | −8.7072E−06 | 1.1169E−06 | −8.0485E−08 |
| R3 | 1.6152E+00 | −3.3371E−05 | 5.8113E−06 | −5.6767E−07 | 2.4055E−08 |
| R4 | −2.3141E−01 | 5.8232E−05 | −1.0263E−05 | 9.8548E−07 | −3.9106E−08 |
| R5 | −7.1176E+01 | −2.3676E−04 | 3.8952E−05 | −3.5666E−06 | 1.3699E−07 |
| R6 | −5.6865E+01 | −2.2082E−04 | 1.0806E−05 | 3.6433E−06 | −6.9150E−07 |
| R7 | −9.8980E+01 | −1.2065E−03 | 3.1289E−04 | −5.6218E−05 | 6.7612E−06 |
| R8 | 1.0783E+01 | 1.5489E−04 | −3.4362E−05 | 4.8957E−06 | −4.3052E−07 |
| R9 | −3.1642E+00 | −2.7827E−03 | 6.2947E−04 | −1.0388E−04 | 1.2443E−05 |
| R10 | 3.6331E+01 | −4.7552E−04 | 1.0924E−04 | −1.6776E−05 | 1.7811E−06 |
| R11 | −6.3315E+00 | 9.8342E−05 | −1.3607E−05 | 1.2983E−06 | −8.6373E−08 |
| R12 | −1.0000E+00 | −8.9239E−05 | 8.8294E−06 | −6.4947E−07 | 3.5382E−08 |
| R13 | −1.4876E+00 | −3.9740E−06 | 5.2963E−07 | −4.2414E−08 | 2.2571E−09 |
| R14 | −1.0066E+00 | 1.1453E−05 | −9.7656E−07 | 6.2273E−08 | −2.9248E−09 |

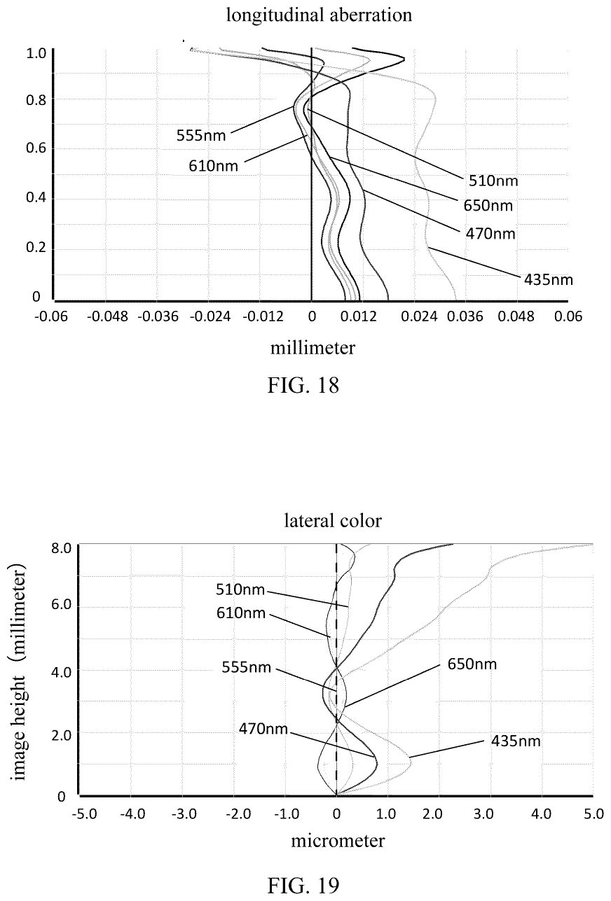

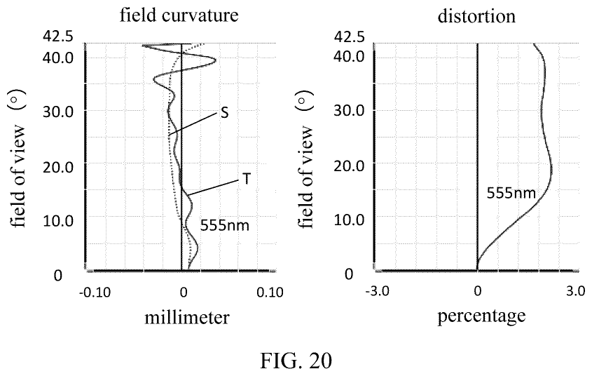

FIG. 18 and FIG. 19 respectively show longitudinal aberration and lateral color of light with wavelengths of 655 nm, 610 nm, 555 nm, 510 nm, 470 nm, and 435 nm after passing through the camera optical lens 50 according to Embodiment 5. FIG. 20 shows field curvature and distortion of light with a wavelength of 555 nm after passing through the camera optical lens 50 according to Embodiment 5. The field curvature S in FIG. 20 is the field curvature in the sagittal direction, and T is the field curvature in the meridian direction.

In this embodiment, the entrance pupil diameter ENPD of the camera optical lens 50 is 5.219 mm, the 1.0 field of view image height IH is 8.000 mm, the MIC field of view image height is 8.290 mm, the 1.0 field of view FOV is 84.95°, and the MIC field of view FOV is 86.97°. The camera optical lens 50 meets the design requirements of small aberration, high light flux, good processability, low assembling sensitivity, wide-angle, ultra-thin and has good optical characteristics.

Table 11 appears later to show values of various values in Embodiment 1, Embodiment 2, Embodiment 3, Embodiment 4, and Embodiment 5 corresponding to parameters specified in the conditional formula.

TABLE 11

| Parameters and | Embodiment | Embodiment | Embodiment | Embodiment | Embodiment |
|---|---|---|---|---|---|
| Relational Expressions | 1 | 2 | 3 | 4 | 5 |
| f12/f34567 | −0.206 | 0.034 | −0.090 | 0.010 | 0.037 |
| \|TEP/SAG11\|*(f/R1) | 2.362 | 0.207 | 0.215 | 0.206 | 0.160 |
| SZD1/HZD1 | 0.199 | 0.214 | 0.190 | 0.216 | 0.247 |
| SZD2/HZD2 | 0.128 | 0.167 | 0.088 | 0.169 | 0.213 |
| (f5 − f6)/f | −4.214 | −2.094 | −3.576 | −2.079 | −1.775 |
| d4/(d2 + d6) | 1.823 | 1.379 | 1.669 | 1.379 | 1.341 |
| SAG51/d8 | −1.129 | −0.978 | −1.221 | −1.036 | −1.074 |
| SFD1/HFD1 | 0.192 | 0.209 | 0.182 | 0.210 | 0.242 |
| SFD2/HFD2 | −0.063 | −0.029 | −0.099 | −0.030 | 0.001 |
| SFD3/HFD3 | 0.113 | 0.154 | 0.375 | 0.155 | 0.199 |
| (SAG61 − SAG62)/d11 | 0.440 | 0.263 | 0.232 | 0.347 | 0.315 |
| f | 8.57 | 8.378 | 8.453 | 8.475 | 8.606 |
| f1 | 9.33 | 9.739 | 9.64 | 9.967 | 9.777 |
| f2 | −47.905 | −56.823 | −68.053 | −62.345 | −48.84 |
| f3 | −33.286 | −43.481 | −31.118 | −43.732 | −27.814 |
| f4 | 42.842 | 27.646 | 54.525 | 26.92 | 24.816 |
| f5 | −29.483 | −11.235 | −25.008 | −11.318 | −9.988 |
| f6 | 6.635 | 6.308 | 5.221 | 6.303 | 5.288 |
| f7 | −5.879 | −9.541 | −5.208 | −9.042 | −8.162 |
| FNO | 1.691 | 1.650 | 1.670 | 1.650 | 1.649 |
| TTL | 10.220 | 10.199 | 10.151 | 10.041 | 10.250 |

Those skilled in the art may understand that the above embodiments are specific embodiments for implementing the present disclosure, and in practical applications, various changes may be made in form and detail without departing from the spirit and scope of the present disclosure.

What is claimed is:

1. A camera optical lens, sequentially comprising an aperture stop and seven lenses from an object side to an image side: a first lens having positive refractive power, a second lens having negative refractive power, a third lens having negative refractive power, a fourth lens having positive refractive power, a fifth lens having negative refractive power, a sixth lens having positive refractive power, and a seventh lens having negative refractive power;
wherein an object-side surface of the first lens is convex, an image-side surface of the first lens is concave; an object-side surface of the second lens is convex, an image-side surface of the second lens is concave; an image-side surface of the third lens is concave; an object-side surface of the fourth lens is convex, an image-side surface of the fourth lens is convex; an image-side surface of the fifth lens is concave; an object-side surface of the sixth lens is convex; an image-side surface of the seventh lens is concave;
wherein a combined focal length of the first lens and the second lens is defined as f12, a combined focal length of the third lens, the fourth lens, the fifth lens, the sixth lens and the seventh lens is defined as f34567, a distance from the aperture stop to a center of the object-side surface of the first lens along an optical axis direction is defined as TEP, a sagittal height at a maximum optical radius of the object-side surface of the sixth lens is defined as SAG11, a focal length of the camera optical lens is defined as f, a central curvature radius of the object-side surface of the first lens in the paraxial region is defined as R1, the object-side surface and an image-side surface of the sixth lens each comprise at least one critical point, a critical point on the object-side surface of the sixth lens closest to the optical axis is defined as a first object side critical point, a vertical distance between the first object side critical point and the optical axis is defined as HZD1, a sagittal height of the first object side critical point is defined as SZD1, a critical point on the image-side surface of the sixth lens closest to the optical axis is defined as a first image side critical point, a vertical distance between the first image side critical point and the optical axis is defined as HZD2, a sagittal height of the first image side critical point is defined as SZD2, a focal length of the fifth lens is defined as f5, a focal length of the sixth lens is defined as f6, an on-axis distance between the image-side surface of the first lens and the object-side surface of the second lens is defined as d2, an on-axis distance between the image-side surface of the second lens and an object-side surface of the third lens is defined as d4, an on-axis distance between the image-side surface of the third lens and the object-side surface of the fourth lens is defined as d6, a sagittal height at a maximum optical radius of an object-side surface of the fifth lens is defined as SAG51, an on-axis distance between the image-side surface of the fourth lens and the object-side surface of the fifth lens is defined as d8, and following relational expressions are satisfied:
$$- 0.25 \leq f 12 / f 34567 \leq 0 \text{.05} ;$$
$$0.13 \leq \vert TEP / SAG 11 \vert * ( f / R 1 ) \leq 2 \text{.80} ;$$
$$0.15 \leq SZD 1 / HZD 1 \leq 0.3 ;$$
$$0.07 \leq SZD 2 / HZD 2 \leq 0.25 ;$$
$$- 5. \leq ( f 5 - f 6 ) / f \leq - 1.4 ;$$
$$1.2 \leq d 4 / ( d 2 + d 6 ) \leq 2. ; and$$
$$- 1.5 \leq SAG 51 / d 8 \leq - 0.90 .$$

2. The camera optical lens as described in claim 1, wherein a following relational expression is satisfied: −0.21≤f12/f34567≤0.04.

3. The camera optical lens as described in claim 1, wherein a following relational expression is satisfied: 0.15≤|TEP/SAG11|*(f/R1)≤2.50.

4. The camera optical lens as described in claim 1, wherein a following relational expression is satisfied: 0.18≤SZD1/HZD1≤0.25.

5. The camera optical lens as described in claim 1, wherein a following relational expression is satisfied: 0.08≤SZD2/HZD2≤0.22.

6. The camera optical lens as described in claim 1, wherein a following relational expression is satisfied: −4.40≤(f5−f6)/f≤−1.70.

7. The camera optical lens as described in claim 1, wherein a following relational expression is satisfied: 1.30≤d4/(d2+d6)≤1.85.

8. The camera optical lens as described in claim 1, wherein a following relational expression is satisfied: −1.25≤SAG51/d8≤−0.95.

9. The camera optical lens as described in claim 1, wherein a sagittal height at a maximum optical radius of an object-side surface of the sixth lens is defined as SAG61, a sagittal height at a maximum optical radius of an image-side surface of the sixth lens is defined as SAG62, an on-axis thickness of the sixth lens is defined as d11, and a following relational expression is satisfied: 0.20≤(SAG61−SAG62)/d11≤0.50.

10. The camera optical lens as described in claim 9, wherein a following relational expression is satisfied: 0.23≤(SAG61−SAG62)/d11≤0.45.

11. The camera optical lens as described in claim 1, wherein a central curvature radius of the object-side surface of the second lens in the paraxial region is defined as R3, a central curvature radius of the image-side surface of the fifth lens in the paraxial region is defined as R10, and a following relational expression is satisfied: 0.28≤R3/R10≤2.65.

12. The camera optical lens as described in claim 11, wherein a following relational expression is satisfied: 0.33≤R3/R10≤2.28.

13. The camera optical lens as described in claim 1, wherein the first lens is made of glass.

14. A camera optical lens, sequentially comprising an aperture stop and seven lenses from an object side to an image side: a first lens having positive refractive power, a second lens having negative refractive power, a third lens having negative refractive power, a fourth lens having positive refractive power, a fifth lens having negative refractive power, a sixth lens having positive refractive power, and a seventh lens having negative refractive power;
wherein an object-side surface of the first lens is convex, an image-side surface of the first lens is concave; an object-side surface of the second lens is convex, an image-side surface of the second lens is concave; an image-side surface of the third lens is concave; an object-side surface of the fourth lens is convex, an image-side surface of the fourth lens is convex; an image-side surface of the fifth lens is concave; an object-side surface of the sixth lens is convex; an image-side surface of the seventh lens is concave;
wherein a combined focal length of the first lens and the second lens is defined as f12, a combined focal length of the third lens, the fourth lens, the fifth lens, the sixth lens and the seventh lens is defined as f34567, a distance from the aperture stop to a center of the object-side surface of the first lens along an optical axis direction is defined as TEP, a sagittal height at a maximum optical radius of the object-side surface of the sixth lens is defined as SAG11, a focal length of the camera optical lens is defined as f, a central curvature radius of the object-side surface of the first lens in the paraxial region is defined as R1, the object-side surface and an image-side surface of the sixth lens each comprise at least one critical point, a critical point on the object-side surface of the sixth lens closest to the optical axis is defined as a first object side critical point, a vertical distance between the first object side critical point and the optical axis is defined as HZD1, a sagittal height of the first object side critical point is defined as SZD1, a critical point on the image-side surface of the sixth lens closest to the optical axis is defined as a first image side critical point, a vertical distance between the first image side critical point and the optical axis is defined as HZD2, a sagittal height of the first image side critical point is defined as SZD2, the object-side surface and the image-side surface of the sixth lens comprise at least one arrest point, the object-side surface of the sixth lens comprises a first object side arrest point closest to the optical axis and a second object side arrest point other than the first object side arrest point, a vertical distance from the first object side arrest point to the optical axis is defined as HFD1, a sagittal height of the first object side arrest point is defined as SFD1, a vertical distance from the second object side arrest point to the optical axis is defined as HFD2, a sagittal height of the second object side arrest point is defined as SFD2, the image-side surface of the sixth lens comprises a first image side arrest point closest to the optical axis, a vertical distance between the first image side arrest point and the optical axis is defined as HFD3, a sagittal height of the first image side arrest point is defined as SFD3, and following relational expressions are satisfied:
$$- 0.25 \leq f 12 / f 34567 \leq 0 \text{.05} ;$$
$$0.13 \leq \vert TEP / SAG 11 \vert * ( f / R 1 ) \leq 2 \text{.80} ;$$
$$0.15 \leq SZD 1 / HZD 1 \leq 0.3 ;$$
$$0.07 \leq SZD 2 / HZD 2 \leq 0.25 ;$$
$$0.15 \leq SFD 1 / HFD 1 \leq 0 \text{.28} ;$$
$$- 0.1 \; 2 \leq SFD 2 / HFD 2 \leq 0.0 \; 02 ; and$$
$$0.1 \leq SFD 3 / HFD 3 \leq 0.45 .$$

15. The camera optical lens as described in claim 14, wherein a following relational expression is satisfied: −0.21≤f12/f34567≤0.04.

16. The camera optical lens as described in claim 14, wherein a following relational expression is satisfied: 0.15≤|TEP/SAG11|*(f/R1)≤2.50.

17. The camera optical lens as described in claim 14, wherein a following relational expression is satisfied: 0.18≤SZD1/HZD1≤0.25.

18. The camera optical lens as described in claim 14, wherein a following relational expression is satisfied: 0.08≤SZD2/HZD2≤0.22.

19. The camera optical lens as described in claim 14, wherein a following relational expression is satisfied: 0.18≤SFD1/HFD1≤0.25.

20. The camera optical lens as described in claim 14, wherein a following relational expression is satisfied: −0.10≤SFD2/HFD2≤0.002.

21. The camera optical lens as described in claim 14, wherein a following relational expression is satisfied: 0.11≤SFD3/HFD3≤0.38.

22. The camera optical lens as described in claim 14, wherein a focal length of the sixth lens is f6, an on-axis thickness of the sixth lens is d11, and a following relational expression is satisfied: 6.58≤f6/d11≤11.78.

23. The camera optical lens as described in claim 22, wherein a following relational expression is satisfied: 7.69≤f6/d11≤9.85.

24. The camera optical lens as described in claim 14, wherein the first lens is made of glass.
